(19) United States
(12) Patent Application Publication
(10) Pub. No.: US 2026/0309893 A1
(43) Pub. Date: Oct. 8, 2026

(54) SYSTEM AND METHOD FOR ESTIMATING AND FORECASTING SOIL MOISTURE CONTENT

(71) Applicant: United States Golf Association, Liberty Corner, NJ (US)

(72) Inventors: Matthew Pringle, Pinehurst, NC (US); Jordan Booth, Pinehurst, NC (US); Scott Mingay, Madison, NJ (US); Matteo Serena, Covina, CA (US); Wesley Stewart, Sanford, NC (US); Cole Steven Thompson, West End, NC (US)

(21) Appl. No.: 19/576,244

(22) Filed: Mar. 24, 2026

Related U.S. Application Data
(60) Provisional application No. 63/776,443, filed on Mar. 24, 2025.

(51) Int. Cl. G01W 1/10; G01W 1/14

(52) U.S. Cl. CPC G01W 1/10; G01W 1/14

(57) ABSTRACT

A system and associated method for estimating and forecasting soil volumetric moisture content, including ingesting data obtained from one or more data sources, where the data of the one or more data sources include one or more of soil data, topography data, rainfall data, weather service data, weather station data, and portable moisture meter data, processing and storing the ingested data, executing a machine learning component of an adaptive machine learning platform to generate a machine learning component output, where the machine learning component output is generated based at least in part on the processed and stored data, and generating a soil volumetric moisture content estimate or forecast based at least in part on the machine learning component output.

### CROSS-REFERENCE TO RELATED APPLICATIONS

This application claims priority to U.S. Provisional Patent Application No. 63/776,443, filed Mar. 24, 2025, the disclosure and teachings of which are incorporated herein by reference.

### TECHNICAL FIELD

The present application relates to a system and method for accurately estimating and forecasting soil moisture content with geospatial and temporal precision.

### BACKGROUND OF THE INVENTION

Nine cardinal environmental parameters have been described as being determinative of plant growth-light, air temperature, air vapor pressure, air carbon dioxide concentration, wind speed, soil pore water, soil nutrients, soil temperature, and soil oxygen concentration. However, excess water, i.e., an amount more than that required to promote plant health and vigor, is both wasteful, due to increased evaporation and transpiration, and can promote harmful microorganisms, such as molds, yeasts, and bacteria. Therefore, successful agronomists actively manage the availability of water to their crops. Water is also carefully managed by turfgrass superintendents, such as on golf courses, parks, and sports fields, and by ornamental landscape managers.

There are many methods of measuring and estimating the volumetric water content (VWC) of the soils in which plants are growing, ranging from visual inspection and touching of the soil and the plant itself, to the use of weather records and forecasts, to the weighing and drying of soil samples, and to devices that use contact and non-contact methods to measure VWC.

Unfortunately, none of these methods is entirely satisfactory. Some methods can provide real-time measurements for specific, discrete locations, whereas others provide geo-spatially broad measures, i.e., heat maps, at specific instances in time. All methods have varying degrees of accuracy, which can range from highly accurate to grossly inaccurate.

The desired goal for any agronomist and manager of plants would be to receive highly accurate, real-time, and geospatially precise estimates of the VWC that can be efficiently collected for the property under their management. Forecasting near-term future VWC would also benefit the optimization and conservation of soil moisture and irrigation water. The present invention describes a system for utilizing multiple sources of data to provide improved estimates and forecasts of VWC with geospatial and temporal precision using machine learning and artificial intelligence.

In many parts of the world, water is a limited and expensive resource that is critical to plant growth and therefore productivity of any agronomic system. This invention will provide agronomists with an important tool to understand and forecast optimized water needs of their system to reduce excess water consumption.

### Water Requirements for Plants Including Turfgrasses

Water is vital to plant growth. It provides cell turgidity for stability and elongation, directly contributing to plant growth and structure. Biochemically, water molecules support certain metabolic processes, such as photosynthesis and cellular respiration. However, 98% of the water absorbed by plant roots is passively transpired through plant conductive tissues, carrying essential mineral elements in solution to support plant metabolism. The combined loss of water to the atmosphere from evaporation from leaves and soil and transpiration through plants is termed evapotranspiration (ET) and is the most direct measure of plant water consumption.

Evapotranspiration is driven primarily by environmental factors such as air temperature, relative humidity, wind speed, solar radiation, and soil moisture. However, consumptive water use among plants differs greatly-primarily controlled by a plant's photosynthetic pathway, leaf morphology and anatomy, root architecture, growth rate, and overall plant stature. Even the consumptive water use of a single plant will vary as environmental conditions change, which exemplifies the importance of simultaneously considering environmental and biological factors in an effort to use machine learning and artificial intelligence to estimate and predict the sufficiency of soil VWC for plant growth.

Over many years, scientists have measured ET for various plants and in various conditions to model plant water use. Reference ET (ET_{O}), which estimates the actual ET of a closely cut grass crop, is commonly used as a baseline that can be adapted to estimate ET for a specific crop (ET_{C}) using crop coefficients (K_{C}). Plant ET can vary from less than 0.05 inches to more than 0.3 inches per day, depending on species and environmental conditions.

### Global Water Supply Risks and Concerns

Golf courses cannot exist without water. It would be ideal for precipitation to provide what golf courses need but, even in wetter climates, rain rarely falls in the amount and frequency ideal for turfgrass health or golf course playability. As such, every golf course requires some form of supplemental irrigation, and best estimates indicate that U.S. golf courses use 1.69 million acre-ft of water per year, largely from wells (32%), surface waters such as lakes and ponds (23%), recycled wastewater (21%) and municipal sources (9%) (Shaddox et al., 2022).

Perhaps unfairly, golf is often scrutinized for its use of water. But contrary to what many believe, golf courses are very efficient water users representing a very small part of total U.S. water use. The U.S. withdraws nearly 365 million acre-ft of water per year-37% of which (135 million acre-ft) is used for irrigation (USGS, 2015). This means that U.S. golf courses account for 1.3% of irrigation water use in the U.S. annually, and total use has declined by almost 30% since 2005, mostly due to more efficient irrigation practices (Shaddox et al., 2022). However, such a broad brush cannot fully describe the water use, supply, or necessary conservation realities for myriad golf courses in different climates and with different goals, expectations, resources, and regulations.

Water is becoming more expensive and increasingly regulated where it is most scarce, and climate change is expected to disproportionally strain water resources over the next 25 years. Regions with higher relative precipitation, such as the eastern third of the U.S., are likely to receive a little more annual precipitation, but those already strained, such as the middle of the country and most of the west, are expected to receive less (Uhlenbrook and Connor, 2019). At the same time, the United Nations projects that global water use will continue to increase by 1% annually until 2050, and the U.S. intelligence community has projected that freshwater availability will insufficiently meet demands for food and energy production in many countries 10 years before that (Uhlenbrook and Connor, 2019; Kojm et al., 2012). Regardless of how little water the golf industry uses, we need to continue to find ways to further conserve.

Even if water conservation is not a primary concern for a golf facility, it is important to remember that more precise irrigation begets better and more uniform playing conditions, and something as simple as irrigating less turfgrass area within a golf course can reduce maintenance costs and emissions, and create opportunities for naturalization to increase the ecosystem services value of a golf course. Using less water also means less pumping which, in turn, means less energy use and fewer utility costs to pay for power to pump irrigation water. A final point is perhaps that every golf course should have a conservation plan because water restrictions will eventually happen everywhere, even if only transiently.

### Relevant Sources of Data

Table 1 provides a non-exhaustive sample of relevant data that the present invention incorporates to provide an accurate VWC estimate with geospatial and temporal precision.

TABLE 1
Relevant, Non-Exhaustive Data Types and Examples

| | | | Instantaneous | Point or | |
|---|---|---|---|---|---|
| Data Type | Examples | Accuracy | Assessment | Area? | Real Time |
| Contact soil | Portable soil | High | Yes | Multiple | No |
| moisture | moisture meter | | | Points | |
| measurement | In-ground soil | High | Yes | Point | Yes |
| | moisture meter | | | | |
| | Gravimetric | High | No | Multiple | No |
| | sampling | | | Points | |
| Non-contact | Ground-based | Medium | No | Area | No |
| moisture | microwave | | | | |
| measurement | radiometer | | | | |
| | Satellite-based | Low | Yes | Area | No |
| | active/passive | | | | |
| | sensory | | | | |
| Weather data | Rainfall meter | High | Yes | Point | Yes |
| | Evapotranspiration | Medium | Yes | Point | Yes |
| | from weather station | | | | |
| | Rainfall forecast | Low | Yes | Area | Yes |
| | Evapotranspiration | Low | Yes | Area | Yes |
| | forecast | | | | |
| Irrigation data | Irrigation timer | Medium | Yes | | Yes |
| | Flow meter | High | Yes | Area | Yes |
| Soil and | Hydraulic | Medium | No | Point | No |
| hydraulic data | conductivity | | | | |
| | Topographical map | High | Yes | Area | No (but |
| | | | | | typically not |
| | | | | | changing) |
| Observational | Turf quality | Low | Yes | Area | No |
| data | assessment | | | | |

### SUMMARY OF THE INVENTION

In general, in one aspect, exemplary embodiments of the present application provide a system for estimating and forecasting soil volumetric moisture content, the system including one or more processors, one or more computer-readable media, and one or more modules maintained on the one or more computer-readable media that, when executed by the one or more processors, cause the one or more processors to perform operations including ingesting data obtained from one or more data sources, where the data of the one or more data sources include one or more of soil data, topography data, rainfall data, weather service data, weather station data, and portable moisture meter data, processing and storing the ingested data, executing a machine learning component of an adaptive machine learning platform to generate a machine learning component output, where the machine learning component output is generated based at least in part on the processed and stored data, and generating a soil volumetric moisture content estimate or forecast based at least in part on the machine learning component output.

Implementations of the various exemplary embodiments of the present application may include one or more of the following features. The system may further include one or more sensors or meters configured to obtain the data of the one or more data sources. The one or more sensors or meters may include one or more of an in-ground soil moisture meter, a ground-based microwave radiometer, a rainfall meter, and an irrigation flow meter. The one or more sensors or meters may be configured to continuously communicate data for ingestion by the system. The data of the one or more data sources may include soil data, topography data, rainfall data, weather service data, weather station data, and portable moisture meter data. The processed data may be stored in a centralized cloud-based data repository. The adaptive machine learning platform may be continuously updated based on additional data obtained from the one or more data sources. The soil volumetric moisture content estimate or forecast may be deployed by a mobile application, a web application, or an integrated application programming interface. The data of the one or more data sources may be obtained at or from one or more golf courses.

In general, in another aspect, exemplary embodiments of the present application provide a method for estimating and forecasting soil volumetric moisture content, the method including, under control of one or more processors configured with executable instructions, ingesting data obtained from one or more data sources, where the data of the one or more data sources include one or more of soil data, topography data, rainfall data, weather service data, weather station data, and portable moisture meter data, processing and storing the ingested data, executing a machine learning component of an adaptive machine learning platform to generate a machine learning component output, where the machine learning component output is generated based at least in part on the processed and stored data, and generating a soil volumetric moisture content estimate or forecast based at least in part on the machine learning component output.

Implementations of the various exemplary embodiments of the present application may include one or more of the following features. One or more sensors or meters may obtain the data of the one or more data sources. The one or more sensors or meters may include one or more of an in-ground soil moisture meter, a ground-based microwave radiometer, a rainfall meter, and an irrigation flow meter. The one or more sensors or meters may continuously communicate data for ingestion by the system. The data of the one or more data sources may include soil data, topography data, rainfall data, weather service data, weather station data, and portable moisture meter data. The processed data may be stored in a centralized cloud-based data repository. The adaptive machine learning platform may be continuously updated based on additional data obtained from the one or more data sources. The soil volumetric moisture content estimate or forecast may be deployed by a mobile application, a web application, or an integrated application programming interface. The data of the one or more data sources may be obtained at or from one or more golf courses.

### BRIEF DESCRIPTION OF DRAWINGS

The aforementioned and other aspects, features and advantages can be more readily understood from the following detailed description with reference to the accompanying drawings, wherein:

FIG. 1 shows a block diagram of the system architecture for a soil moisture content estimating and forecasting system according to an embodiment of the present application.

### DETAILED DESCRIPTION OF THE INVENTION

In describing preferred embodiments illustrated in the drawings, specific terminology is employed herein for the sake of clarity. However, this disclosure is not intended to be limited to the specific terminology so selected, and it is to be understood that each specific element includes all technical equivalents that operate in a similar manner. In addition, a detailed description of known functions and configurations is omitted from this specification when it may obscure the inventive aspects described herein.

Table 1 includes a wide variety of sensors, measures, and other forms of data that can be used to estimate point and area VWC at both specific instances in time, in real-time, and forecasts for future time, and with a range of accuracies. However, none of the individual sources listed in Table 1 can provide accurate and real-time estimates with geospatial precision over broad and continuous areas of the managed plants. Therefore, it is the objective of this invention to provide a machine learning system to incorporate one or more of these data sources, such recited data sources not being exhaustive, to provide estimates of soil VWC across the managed areas in real-time and/or forecasted future times.

It is a further objective of this invention that the system improves the accuracy and geo-spatial precision of these estimates with increasing sources of data. Moreover, many of the sensors that are used to measure soil VWC also measure the bulk electrical conductivity (EC) and/or soil pore water EC, which is a measure of salt content, as well as soil and surface temperatures, both of which impact the growth potential of plants. Therefore, it is a further objective of this invention that the machine learning system also provide accurate, geo-spatially precise, real-time and forecasts of these important measures.

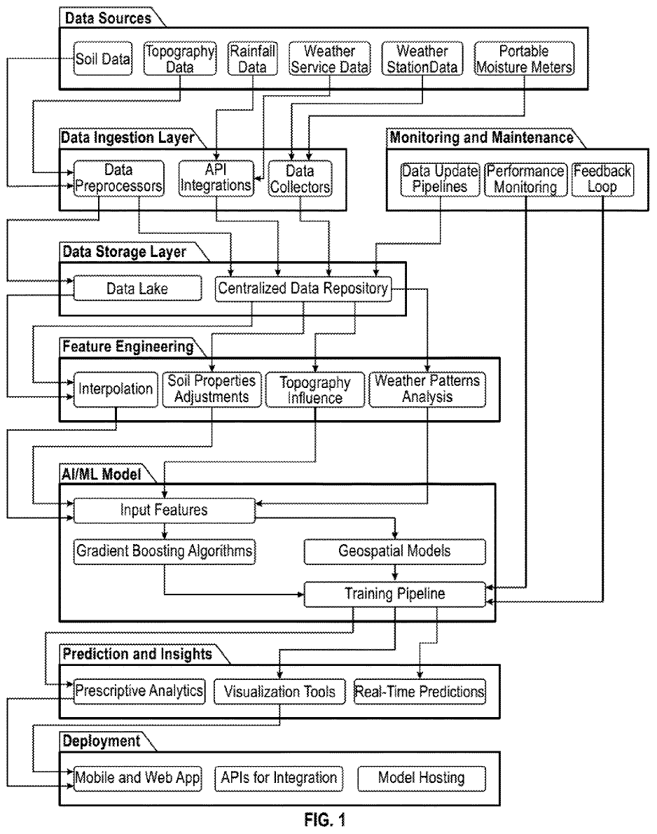

FIG. 1 provides an illustration of the system architecture for a soil moisture content estimating and forecasting system according to one embodiment of the present application.

The data ingestion layer plays a critical role in consolidating inputs from various sources to create a unified dataset. Portable moisture meter readings and on-site weather station data are collected using dedicated data collectors, ensuring real-time integration. Additionally, external APIs are employed to fetch supplementary information, such as regional weather trends and rainfall data. To maintain consistency and usability, preprocessing techniques standardize the data by normalizing units and handling outliers, preparing it for storage and analysis.

Processed data is stored in a centralized cloud-based repository designed for efficient retrieval and scalability. This repository holds time-series data, geospatial details, and historical moisture readings, creating a rich dataset for model training and predictions. For less structured information, such as raw GIS files or sensor logs, a data lake is utilized. This layered storage approach ensures that both structured and unstructured data are readily accessible for downstream processes.

Feature engineering transforms raw data into actionable insights by leveraging advanced techniques. Sparse moisture readings are interpolated to generate a comprehensive map of soil conditions across the golf course. Weather patterns, including temperature and precipitation trends, are analyzed for their impact on moisture retention. Topographical data, such as slope and elevation, is integrated to account for runoff and water pooling effects. Soil properties, including texture and permeability, further refine predictions by adding granularity to the analysis.

The AI/ML model combines diverse input features, including portable moisture readings, weather data, topography, soil characteristics, and rainfall, to generate accurate predictions. Gradient boosting algorithms, such as XGBoost and LightGBM, are employed to handle structured data, while geospatial modeling techniques map moisture distributions across the course. The model training pipeline involves splitting data into training, validation, and testing sets, ensuring robust performance. Hyperparameter tuning is used to optimize the model's accuracy, making it adaptable to varying conditions on the golf course.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawing and descriptive matter in which there are illustrated exemplary embodiments of the invention.

What is claimed is:

1. A system for estimating and forecasting soil volumetric moisture content, the system comprising:
one or more processors;
one or more computer-readable media; and
one or more modules maintained on the one or more computer-readable media that, when executed by the one or more processors, cause the one or more processors to perform operations including:
ingesting data obtained from one or more data sources, wherein the data of the one or more data sources include one or more of soil data, topography data, rainfall data, weather service data, weather station data, and portable moisture meter data;
processing and storing the ingested data;
executing a machine learning component of an adaptive machine learning platform to generate a machine learning component output, wherein the machine learning component output is generated based at least in part on the processed and stored data; and
generating a soil volumetric moisture content estimate or forecast based at least in part on the machine learning component output.

2. The system of claim 1, further comprising:
one or more sensors or meters configured to obtain the data of the one or more data sources.

3. The system of claim 2, wherein the one or more sensors or meters include one or more of an in-ground soil moisture meter, a ground-based microwave radiometer, a rainfall meter, and an irrigation flow meter.

4. The system of claim 2, wherein the one or more sensors or meters are configured to continuously communicate data for ingestion by the system.

5. The system of claim 1, wherein the data of the one or more data sources include soil data, topography data, rainfall data, weather service data, weather station data, and portable moisture meter data.

6. The system of claim 1, wherein the processed data is stored in a centralized cloud-based data repository.

7. The system of claim 1, wherein the adaptive machine learning platform is continuously updated based on additional data obtained from the one or more data sources.

8. The system of claim 1, wherein the soil volumetric moisture content estimate or forecast is deployed by a mobile application, a web application, or an integrated application programming interface.

9. The system of claim 1, wherein the data of the one or more data sources is obtained at or from one or more golf courses.

10. A method for estimating and forecasting soil volumetric moisture content, the method comprising:
under control of one or more processors configured with executable instructions,
ingesting data obtained from one or more data sources, wherein the data of the one or more data sources include one or more of soil data, topography data, rainfall data, weather service data, weather station data, and portable moisture meter data;
processing and storing the ingested data;
executing a machine learning component of an adaptive machine learning platform to generate a machine learning component output, wherein the machine learning component output is generated based at least in part on the processed and stored data; and
generating a soil volumetric moisture content estimate or forecast based at least in part on the machine learning component output.

11. The method of claim 10, wherein one or more sensors or meters obtain the data of the one or more data sources.

12. The method of claim 11, wherein the one or more sensors or meters include one or more of an in-ground soil moisture meter, a ground-based microwave radiometer, a rainfall meter, and an irrigation flow meter.

13. The method of claim 11, wherein the one or more sensors or meters continuously communicate data for ingestion by the system.

14. The method of claim 10, wherein the data of the one or more data sources include soil data, topography data, rainfall data, weather service data, weather station data, and portable moisture meter data.

15. The method of claim 10, wherein the processed data is stored in a centralized cloud-based data repository.

16. The method of claim 10, wherein the adaptive machine learning platform is continuously updated based on additional data obtained from the one or more data sources.

17. The method of claim 10, wherein the soil volumetric moisture content estimate or forecast is deployed by a mobile application, a web application, or an integrated application programming interface.

18. The method of claim 10, wherein the data of the one or more data sources is obtained at or from one or more golf courses.
